(19) United States
(12) Patent Application Publication
(10) Pub. No.: US 2008/0140934 A1
(43) Pub. Date: Jun. 12, 2008

(54) Store-Through L2 Cache Mode

(76) Inventor: David A. Luick, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/609,132

(22) Filed: Dec. 11, 2006

(51) Int. Cl. G06F 12/00

(52) U.S. Cl. 711/117; 711/E12.001

(57) ABSTRACT

A method and apparatus for minimizing unscheduled D-cache miss pipeline stalls is provided. In one embodiment, an L2 cache may be operated in a store-through mode, whereby data from store instructions that cause L1 misses are sent directly to the L2 cache without causing pipeline stalls. The store-through mode may be enabled or disabled (e.g., under software and/or hardware control). Higher levels of cache (e.g., L3 and L4) may also be operated in a store-through mode.

### BACKGROUND OF THE INVENTION

1. Field of the Invention

The present invention generally relates to handling cacheable data in a processor. Specifically, this application is related to minimizing pipeline stalls in a processor due to cache store misses.

2. Description of the Related Art

Modern computer systems typically contain several integrated circuits (ICs), including a processor which may be used to process information in the computer system. The data processed by a processor may include computer instructions which are executed by the processor as well as data which is manipulated by the processor using the computer instructions. The computer instructions and data are typically stored in a main memory in the computer system.

Processors typically process instructions by executing the instruction in a series of small steps. In some cases, to increase the number of instructions being processed by the processor (and therefore increase the speed of the processor), the processor may be pipelined. Pipelining refers to providing separate stages in a processor where each stage performs one or more of the small steps necessary to execute an instruction. In some cases, the pipeline (in addition to other circuitry) may be placed in a portion of the processor referred to as the processor core. Some processors may have multiple processor cores, and in some cases, each processor core may have multiple pipelines. Where a processor core has multiple pipelines, groups of instructions (referred to as issue groups) may be issued to the multiple pipelines in parallel and executed by each of the pipelines in parallel.

As an example of executing instructions in a pipeline, when a first instruction is received, a first pipeline stage may process a small part of the instruction. When the first pipeline stage has finished processing the small part of the instruction, a second pipeline stage may begin processing another small part of the first instruction while the first pipeline stage receives and begins processing a small part of a second instruction. Thus, the processor may process two or more instructions at the same time (in parallel).

To provide for faster access to data and instructions as well as better utilization of the processor, the processor may have several caches. A cache is a memory which is typically smaller than the main memory and is typically manufactured on the same die (i.e., chip) as the processor. Modern processors typically have several levels of caches. The fastest cache which is located closest to the core of the processor is referred to as the Level 1 cache (L1 cache). In addition to the L1 cache, the processor typically has a second, larger cache, referred to as the Level 2 Cache (L2 cache). In some cases, the processor may have other, additional cache levels (e.g., an L3 cache and an L4 cache).

In conventional processors, data caches (L1 D-caches) are operated in a “Store In” manner, generally meaning a copy of the store data is written in the D-cache. Unfortunately, in a store-in cache, pipeline stalls frequently occur in the event of a store miss (meaning a copy of the data line targeted by the store instruction is not in the D-cache). The stall occurs as a copy of the targeted line is fetched from a higher level of cache, as part of a resulting Read-Modify-Write operation to store to the D-cache. Further, D-cache lines are wastefully occupied by store data that is often write-only and not read (at least for some time), resulting in more misses.

Accordingly, there is a need for improved methods and apparatuses for handling data in a processor which utilizes cached memory.

### SUMMARY OF THE INVENTION

The present invention generally provides improved methods and apparatuses for operating a hierarchical cache system in a store-through mode.

One embodiment provides a method of operating a hierarchical cache system in a store-through mode, the cache system including at least a first level (L1) data cache accessible by a pipelined execution unit and a second level (L2) cache. The method generally includes receiving a store instruction by the pipelined execution unit with store data to be stored at a targeted memory address and sending the store data to be stored in the L2 cache without stalling the pipelined execution unit if a cache line containing the targeted memory address is not contained in the L1 data cache.

One embodiment provides an integrated circuit device generally including a first level (L1) data cache, a second level (L2) cache, and at least one processor core having a pipelined execution unit configured to receive a store instruction with store data to be stored at a targeted memory address. Cache control circuitry is configured to send the store data to be stored in the L2 cache without causing the pipelined execution unit to stall if a cache line containing the targeted memory address is not contained in the L1 data cache.

One embodiment provides a system generally including a processor device having a first level (L1) data cache and a second level (L2) cache, at least a third level of cache, and cache control circuitry. The processor device has at least one processor core having a pipelined execution unit configured to receive a store instruction with store data to be stored at a targeted memory address. Cache control circuitry is configured to, in a L3 store-through mode, send the store data to be stored in the L3 cache if a cache line containing the targeted memory address is not contained in the L2 data cache.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram depicting a system according to one embodiment of the invention.

FIG. 2 is a block diagram depicting a computer processor according to one embodiment of the invention.

FIG. 3 is a block diagram depicting one of the cores of the processor according to one embodiment of the invention.

FIG. 4 illustrates exemplary operations for operating an L1/L2 cache hierarchy in a store through manner, according to one embodiment of the invention.

FIG. 5 illustrates an exemplary store-through L2 cache and corresponding data paths, according to one embodiment of the invention.

FIG. 6 illustrates an exemplary store-through L3 cache and corresponding data paths, according to one embodiment of the invention.

### DETAILED DESCRIPTION OF THE PREFERRED EMBODIMENTS

The present invention generally provides methods and apparatus for operating an L2 cache (and possibly higher levels of cache) in a store-through manner. The techniques described herein may result in a reduced number of pipeline stalls resulting from D-cache misses. In addition, operating an L2 cache in a store-through manner may also result in fewer L1 D-cache lines being wastefully used to store write only data that will not be read soon which, ultimately, may result in a reduced number of L1 load misses and further reduce pipeline stalls.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

The following is a detailed description of embodiments of the invention depicted in the accompanying drawings. The embodiments are examples and are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

Embodiments of the invention may be utilized with and are described below with respect to a system, e.g., a computer system. As used herein, a system may include any system utilizing a processor and a cache memory, including a personal computer, internet appliance, digital media appliance, portable digital assistant (PDA), portable music/video player and video game console. While cache memories may be located on the same die as the processor which utilizes the cache memory, in some cases, the processor and cache memories may be located on different dies (e.g., separate chips within separate modules or separate chips within a single module).

While described below with respect to a processor having multiple processor cores and multiple L1 caches, wherein each processor core uses multiple pipelines to execute instructions, embodiments of the invention may be utilized with any processor which utilizes a cache, including processors which have a single processing core. In general, embodiments of the invention may be utilized with any processor and are not limited to any specific configuration. Furthermore, while described below with respect to a processor having an L1 -cache divided into an L1 instruction cache (L1 I-cache, or I-cache) and an L1 data cache (L1 D-cache, or D-cache), embodiments of the invention may be utilized in configurations wherein a unified L1 cache is utilized.

### Overview of an Exemplary System

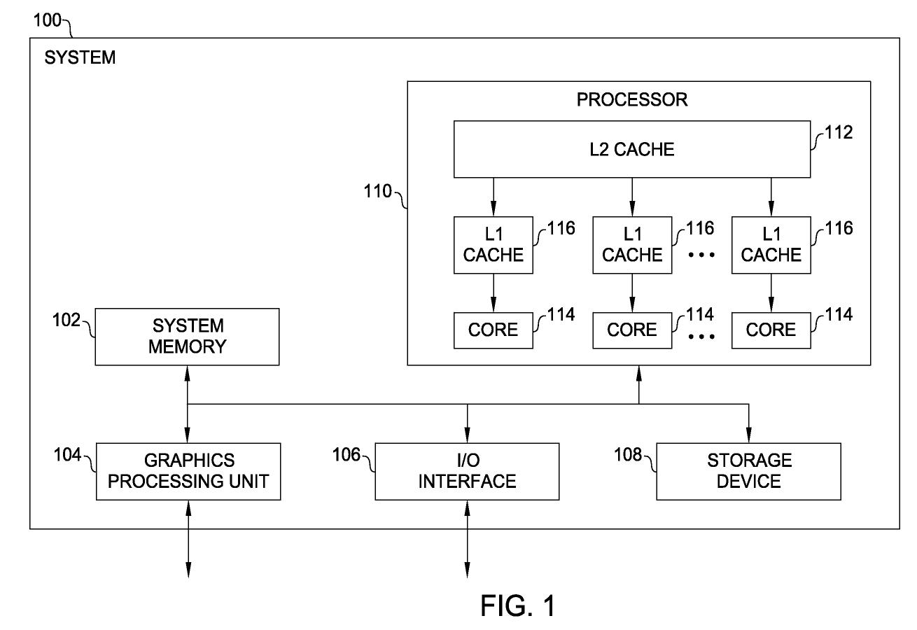

FIG. 1 is a block diagram depicting a system 100 according to one embodiment of the invention. The system 100 may contain a system memory 102 for storing instructions and data, a graphics processing unit 104 for graphics processing, an I/O interface for communicating with external devices, a storage device 108 for long term storage of instructions and data, and a processor 110 for processing instructions and data.

According to one embodiment of the invention, the processor 110 may have an L2 cache 112 as well as multiple L1 caches 116, with each L1 cache 116 being utilized by one of multiple processor cores 114. According to one embodiment, each processor core 114 may be pipelined, wherein each instruction is performed in a series of small steps with each step being performed by a different pipeline stage.

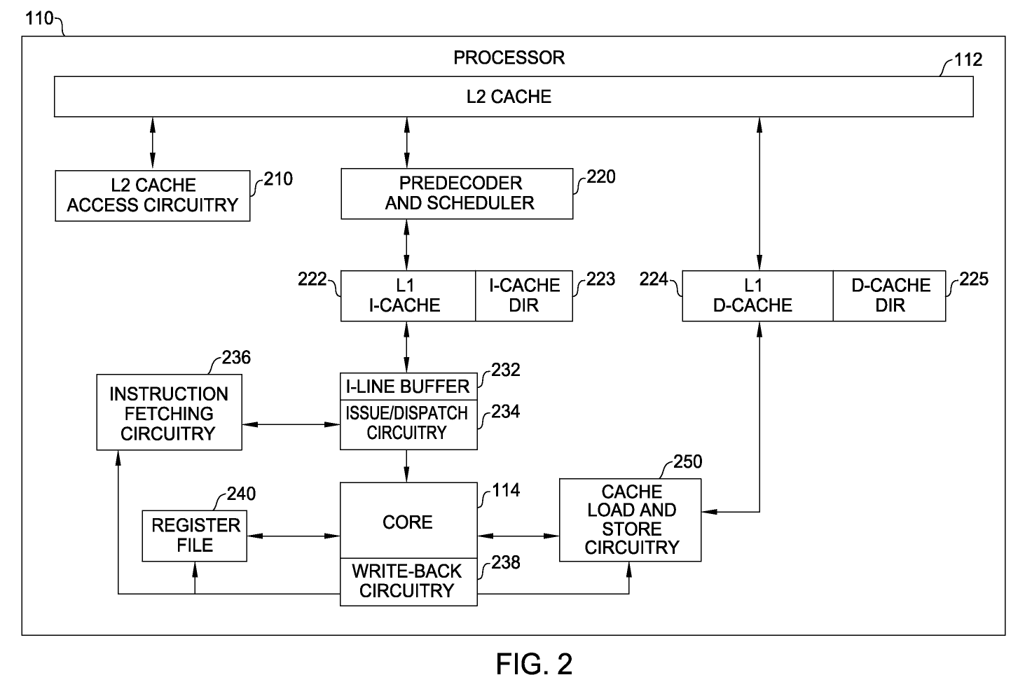

FIG. 2 is a block diagram depicting a processor 110 according to one embodiment of the invention. For simplicity, FIG. 2 depicts and is described with respect to a single core 114 of the processor 110. In one embodiment, each core 114 may be identical (e.g., contain identical pipelines with identical pipeline stages). In another embodiment, each core 114 may be different (e.g., contain different pipelines with different stages).

In one embodiment of the invention, the L2 cache may contain a portion of the instructions and data being used by the processor 110. In some cases, the processor 110 may request instructions and data which are not contained in the L2 cache 112. Where requested instructions and data are not contained in the L2 cache 112, the requested instructions and data may be retrieved (either from a higher level cache or system memory 102) and placed in the L2 cache. When the processor core 114 requests instructions from the L2 cache 112, the instructions may be first processed by a predecoder and scheduler 220 (described below in greater detail).

In one embodiment of the invention, instructions may be fetched from the L2 cache 112 in groups, referred to as I-lines. Similarly, data may be fetched from the L2 cache 112 in groups referred to as D-lines. The L1 cache 116 depicted in FIG. 1 may be divided into two parts, an L1 instruction cache 222 (I-cache 222) for storing I-lines as well as an L1 data cache 224 (D-cache 224) for storing D-lines. I-lines and D-lines may be fetched from the L2 cache 112 using L2 access circuitry 210.

In one embodiment of the invention, I-lines retrieved from the L2 cache 112 may be processed by a predecoder and scheduler 220 and the I-lines may be placed in the I-cache 222. To further improve processor performance, instructions are often predecoded, for example, I-lines are retrieved from L2 (or higher) cache. Such predecoding may include various functions, such as address generation, branch prediction, and scheduling (determining an order in which the instructions should be issued), which is captured as dispatch information (a set of flags) that control instruction execution. In some cases, the predecoder and scheduler 220 may be shared among multiple cores 114 and L1 caches. Similarly, D-lines fetched from the L2 cache 112 may be placed in the D-cache 224. A bit in each I-line and D-line may be used to track whether a line of information in the L2 cache 112 is an I-line or D-line. Optionally, instead of fetching data from the L2 cache 112 in I-lines and/or D-lines, data may be fetched from the L2 cache 112 in other manners, e.g., by fetching smaller, larger, or variable amounts of data.

In one embodiment, the I-cache 222 and D-cache 224 may have an I-cache directory 223 and D-cache directory 225 respectively to track which I-lines and D-lines are currently in the I-cache 222 and D-cache 224. When an I-line or D-line is added to the I-cache 222 or D-cache 224, a corresponding entry may be placed in the I-cache directory 223 or D-cache directory 225. When an I-line or D-line is removed from the I-cache 222 or D-cache 224, the corresponding entry in the I-cache directory 223 or D-cache directory 225 may be removed. While described below with respect to a D-cache 224 which utilizes a D-cache directory 225, embodiments of the invention may also be utilized where a D-cache directory 225 is not utilized. In such cases, the data stored in the D-cache 224 itself may indicate what D-lines are present in the D-cache 224.

In one embodiment, instruction fetching circuitry 236 may be used to fetch instructions for the core 114. For example, the instruction fetching circuitry 236 may contain a program counter which tracks the current instructions being executed in the core. A branch unit within the core may be used to change the program counter when a branch instruction is encountered. An I-line buffer 232 may be used to store instructions fetched from the L1 I-cache 222. Issue and dispatch circuitry 234 may be used to group instructions retrieved from the I-line buffer 232 into instruction groups which may then be issued in parallel to the core 114 as described below. In some cases, the issue and dispatch circuitry may use information provided by the predecoder and scheduler 220 to form appropriate instruction groups.

In addition to receiving instructions from the issue and dispatch circuitry 234, the core 114 may receive data from a variety of locations. Where the core 114 requires data from a data register, a register file 240 may be used to obtain data. Where the core 114 requires data from a memory location, cache load and store circuitry 250 may be used to load data from the D-cache 224. Where such a load is performed, a request for the required data may be issued to the D-cache 224. At the same time, the D-cache directory 225 may be checked to determine whether the desired data is located in the D-cache 224. Where the D-cache 224 contains the desired data, the D-cache directory 225 may indicate that the D-cache 224 contains the desired data and the D-cache access may be completed at some time afterwards. Where the D-cache 224 does not contain the desired data, the D-cache directory 225 may indicate that the D-cache 224 does not contain the desired data. Because the D-cache directory 225 may be accessed more quickly than the D-cache 224, a request for the desired data may be issued to the L2 cache 112 (e.g., using the L2 access circuitry 210) after the D-cache directory 225 is accessed but before the D-cache access is completed.

In some cases, data may be modified in the core 114. Modified data may be written to the register file, or stored in memory. Write back circuitry 238 may be used to write data back to the register file 240. In some cases, the write back circuitry 238 may utilize the cache load and store circuitry 250 to write data back to the D-cache 224. Optionally, the core 114 may access the cache load and store circuitry 250 directly to perform stores. In some cases, as described below, the write-back circuitry 238 may also be used to write instructions back to the I-cache 222.

As described above, the issue and dispatch circuitry 234 may be used to form instruction groups and issue the formed instruction groups to the core 114. The issue and dispatch circuitry 234 may also include circuitry to rotate and merge instructions in the I-line and thereby form an appropriate instruction group. Formation of issue groups may take into account several considerations, such as dependencies between the instructions in an issue group as well as optimizations which may be achieved from the ordering of instructions as described in greater detail below. Once an issue group is formed, the issue group may be dispatched in parallel to the processor core 114. In some cases, an instruction group may contain one instruction for each pipeline in the core 114. Optionally, the instruction group may a smaller number of instructions.

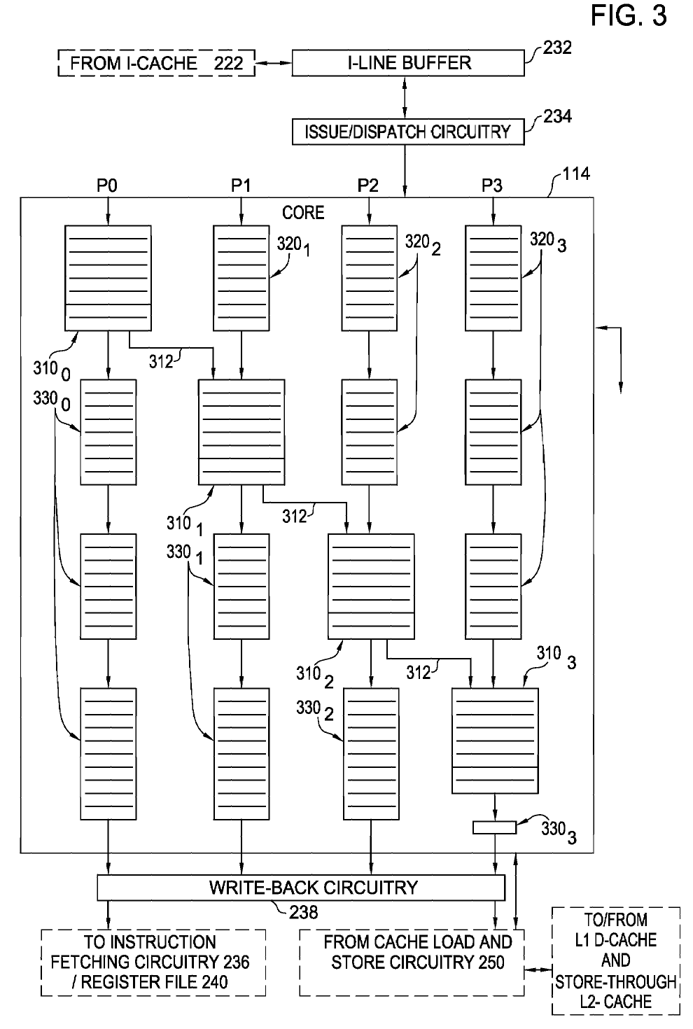

According to one embodiment of the invention, one or more processor cores 114 may utilize a cascaded, delayed execution pipeline configuration. In the example depicted in FIG. 3, the core 114 contains four pipelines in a cascaded configuration. Optionally, a smaller number (two or more pipelines) or a larger number (more than four pipelines) may be used in such a configuration. Furthermore, the physical layout of the pipeline depicted in FIG. 3 is exemplary, and not necessarily suggestive of an actual physical layout of the cascaded, delayed execution pipeline unit.

In one embodiment, each pipeline (P0, P1, P2, P3) in the cascaded, delayed execution pipeline configuration may contain an execution unit 310. The execution unit 310 may contain several pipeline stages which perform one or more functions for a given pipeline. For example, the execution unit 310 may perform all or a portion of the fetching and decoding of an instruction. The decoding performed by the execution unit may be shared with a predecoder and scheduler 220 which is shared among multiple cores 114 or, optionally, which is utilized by a single core 114. The execution unit may also read data from a register file, calculate addresses, perform integer arithmetic functions (e.g., using an arithmetic logic unit, or ALU), perform floating point arithmetic functions, execute instruction branches, perform data access functions (e.g., loads and stores from memory), and store data back to registers (e.g., in the register file 240). In some cases, the core 114 may utilize instruction fetching circuitry 236, the register file 240, cache load and store circuitry 250, and write-back circuitry, as well as any other circuitry, to perform these functions.

In one embodiment, each execution unit 310 may perform the same functions. Optionally, each execution unit 310 (or different groups of execution units) may perform different sets of functions. Also, in some cases the execution units 310 in each core 114 may be the same or different from execution units 310 provided in other cores. For example, in one core, execution units 310₀ and 310₂ may perform load/store and arithmetic functions while execution units 310₁ and 310₂ may perform only arithmetic functions.

In one embodiment, as depicted, execution in the execution units 310 may be performed in a delayed manner with respect to the other execution units 310. The depicted arrangement may also be referred to as a cascaded, delayed configuration, but the depicted layout is not necessarily indicative of an actual physical layout of the execution units. In such a configuration, where instructions (referred to, for convenience, as I0, I1, I2, I3) in an instruction group are issued in parallel to the pipelines P0, P1, P2, P3, each instruction may be executed in a delayed fashion with respect to each other instruction. For example, instruction I0 may be executed first in the execution unit 3100 for pipeline P0, instruction I1 may be executed second in the execution unit 3101 for pipeline P1, and so on.

In one embodiment, upon issuing the issue group to the processor core 114, 10 may be executed immediately in execution unit 3100. Later, after instruction I0 has finished being executed in execution unit 3100, execution unit 3101 may begin executing instruction I1, and so on, such that the instructions issued in parallel to the core 114 are executed in a delayed manner with respect to each other.

In one embodiment, some execution units 310 may be delayed with respect to each other while other execution units 310 are not delayed with respect to each other. Where execution of a second instruction is dependent on the execution of a first instruction, forwarding paths 312 may be used to forward the result from the first instruction to the second instruction. The depicted forwarding paths 312 are merely exemplary, and the core 114 may contain more forwarding paths from different points in an execution unit 310 to other execution units 310 or to the same execution unit 310.

In one embodiment, instructions which are not being executed by an execution unit 310 (e.g., instructions being delayed) may be held in a delay queue 320 or a target delay queue 330. The delay queues 320 may be used to hold instructions in an instruction group which have not been executed by an execution unit 310. For example, while instruction I0 is being executed in execution unit 3100, intructions I1, I2, and I3 may be held in a delay queue 330. Once the instructions have moved through the delay queues 330, the instructions may be issued to the appropriate execution unit 310 and executed. The target delay queues 330 may be used to hold the results of instructions which have already been executed by an execution unit 310. In some cases, results in the target delay queues 330 may be forwarded to executions units 310 for processing or invalidated where appropriate. Similarly, in some circumstances, instructions in the delay queue 320 may be invalidated, as described below.

In one embodiment, after each of the instructions in an instruction group have passed through the delay queues 320, execution units 310, and target delay queues 330, the results (e.g., data, and, as described below, instructions) may be written back either to the register file or the L1 I-cache 222 and/or D-cache 224. In some cases, the write-back circuitry 238 may be used to write back the most recently modified value of a register (received from one of the target delay queues 330) and discard invalidated results.

### A Store-Through L2 Cache Mode

For some embodiments, the L2 cache may be operated in a store-through manner, generally meaning the store data may be sent to the L2 cache regardless of whether the store operation hits or misses in the D-cache. As previously described, by ignoring D-cache store misses, particularly for data that is going to be written to only, pipeline stalls may be avoided. In addition, by freeing up a number of D-cache lines conventionally used to store write-only data, the number of load misses may be significantly reduced, for example, resulting in a load miss rate that may rival or exceed that of conventionally operated (store-in) D-caches of much greater size. As a result, overall processor performance may be greatly improved at minimal cost.

For some embodiments, a “store-through mode” may be enabled/disabled under software and/or hardware control. For example, a software-controllable bit may be provided that, when set (e.g., by operating system code), enables the store-through operation described herein. In addition, or as an alternative, a store through mode may be enabled/disabled under hardware control, for example, with some type of instrumentation logic that monitors pipeline performance. This logic may monitor and record load misses and, for example, if a threshold miss rate is exceeded, enable the store through mode for the L2 cache and/or higher levels of cache.

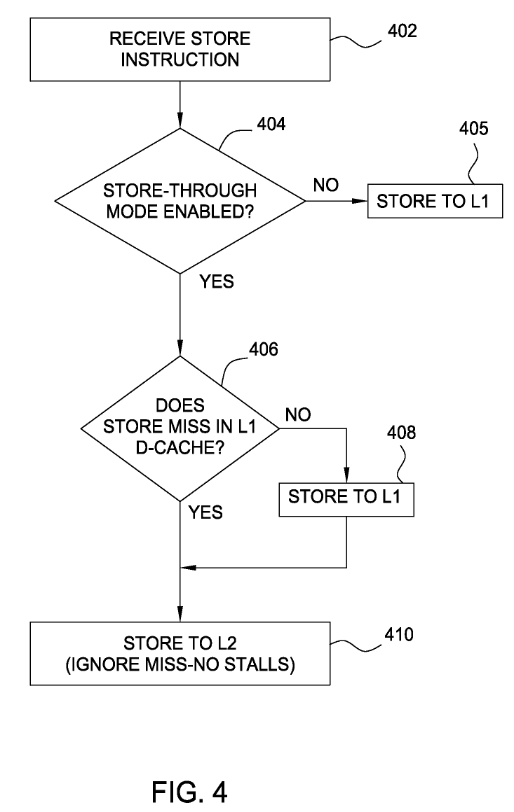

FIG. 4 illustrates exemplary operations 400 for implementing a store-through L2 cache mode according to one embodiment of the invention. The operations 400 may be performed, for example, by the load/store circuitry 250 shown in FIG. 3 or any other suitable logic. While the store-through L2 cache mode operations may be performed to advantage with processor cores that utilize a cascaded, delayed execution pipeline unit 114, as shown in FIG. 3, those skilled in the art will recognize the similar benefits may be achieved by implementing a store-through mode in other types of processor cores.

The operations 400 begin, at step 402, by receiving a store instruction. At step 404, a determination is made as to whether the store-through mode is enabled (e.g., by checking a control bit). If the store-through mode is not enabled, the store data may be sent to the L1 at step 405, for example, to be handled in a conventional manner, which may lead to pipeline stalls in the event of a store miss.

However, if the store-through mode is enabled, the store data may be sent through to the L2 cache, at step 410, regardless of whether the store hits or misses in the D-cache. In other words, any miss may be ignored and the pipeline may continue to operate without stalls.

As illustrated, for some embodiments, if the data hits in the D-cache (a cache line containing the targeted address is already in the D-cache), as determined at step 406, the store data may also be written to the D-cache, at step 408. Updating the L1 in this manner may be beneficial, for example, to avoid a load miss in the event the data is to be read relatively soon. Further, for some embodiments, a “hybrid” approach combining store-in and store-through techniques may be combined. For example, if the data is found in the D-cache, it may be stored there and only sent out to the L2 via conventional cast-out aging mechanisms which may save bandwidth on the bus to the L2. However, if the data is not found in the D-cache, the data may be stored-through to the L2 to prevent stalls.

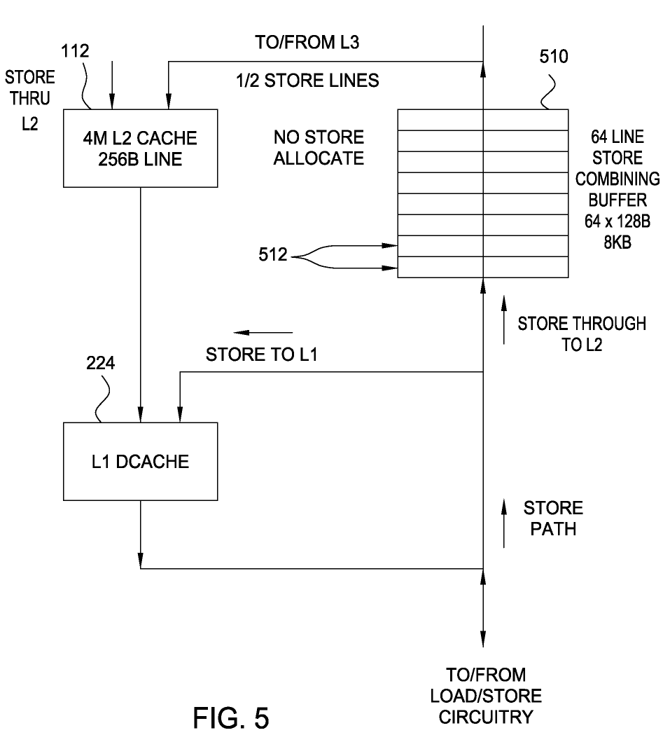

FIG. 5 illustrates an exemplary diagram of a store-through L2 cache mode and corresponding data paths, according to one embodiment of the invention. As illustrated, store data (e.g., from the load/store circuitry 250) may be “stored through” to the L2 cache 112, bypassing the L1 D-cache 224 in the event of a store miss. As described above, the data may still be updated in the D-cache 224 if the targeted cache line is already contained therein (i.e., a store hit).

For some embodiments, a separate store bus may be provided to store through to the L2. The separate store bus may be as wide as a fetch bus or, for some embodiments, less wide (e.g., half width) than the fetch bus. For other embodiments, the fetch bus (or some portion thereof) may be shared and used for storing through to the L2, provided there is sufficient bandwidth.

In some applications, data in an amount less than an entire cache line may be written out. For example, in applications with primarily integer instructions, there may be several (partial) stores to the same cache line. Such partial stores may be problematic in that they may result in a series of read-modify-write operations for each partial store because single bytes cannot be written individually without invalidating error correction codes (ECCs). These multiple read-modify-writes would result in substantial traffic and latency.

In an effort to reduce this traffic on the store bus (whether it is separate or shared), a gather buffer 512 may be provided to consolidate a number of partial stores (that are not to a full cache line or sub-line) to be written together. The gather buffer 512 may be any suitable depth to handle a plurality of cache lines. In the event that there are multiple stores to the same cache line, a copy of the cache line in the gather buffer 512 may be modified without generating a write to the L2. Once the writes have been combined they may be written out as a single cache line.

Depending on the embodiment, data may be written out when a threshold number of writes have been accumulated or based on time (aged out). For some embodiments, the gather buffer 512 may be operated as a simple first-in first-out (FIFO) manner. When data is to be stored to a new cache line, that cache line may be fetched from the L2 and brought into the buffer 512, causing the oldest (First In) to finally be written out to L2. The lines may simply shift in order (e.g., with the second line becoming the third line, the first line becoming the second line, and the new line becoming the first line, assuming a 3-deep FIFO). Various other techniques may also be utilized, for example, writing out the least recently used (LRU) cache lines in the buffer 512.

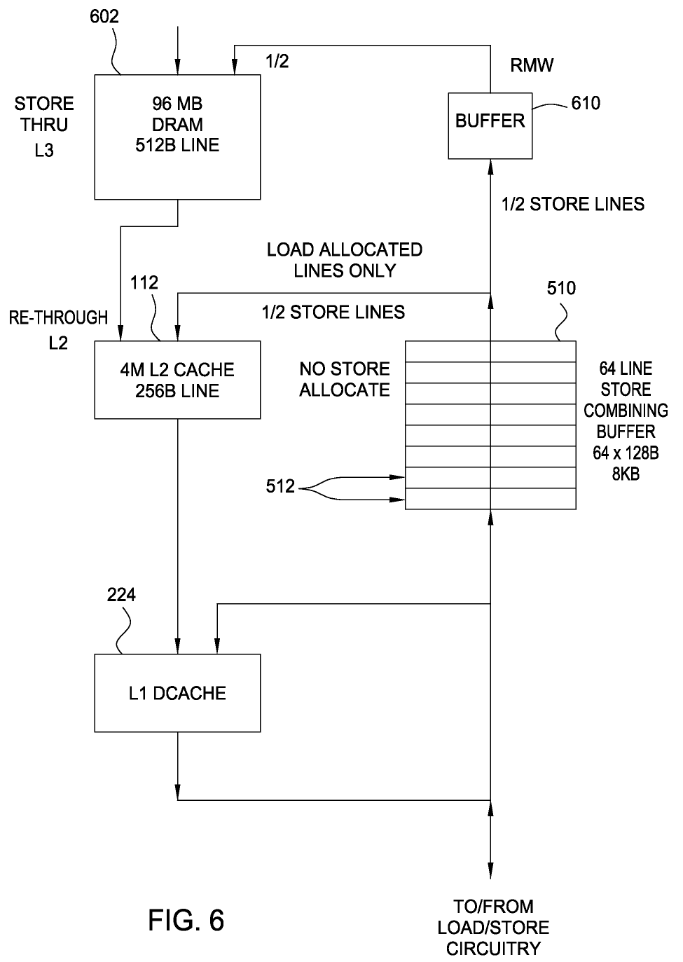

For some embodiments, store through techniques may be applied to similar advantage at higher levels of cache. For example, FIG. 6 illustrates storing through to an L3 cache 602 and corresponding data paths, according to one embodiment of the invention. As described above with reference to the L1 cache, storing through to the L3 cache may result in less store misses in the L2 and more lines available in the L2 for loads, resulting in less load misses.

Data may be stored to the L3 cache 602, regardless of whether there is a hit in the L2. Optionally, in the event of a hit, data may be updated in the L2 cache 112. Further, for some embodiments, a hybrid approach may be employed where data is updated in (stored-in) the L2 cache 112 in the event of a hit and stored-through to the L3 cache 602 in the event of a miss. For some embodiments, a separate store bus may be provided to store through to the L3. However, in the event that L3 cache is off-chip (e.g., external DRAM), a store bus may be shared.

As illustrated, a gather buffer 610 may also be provided to accumulate a number of writes to a common block of data having a predetermined block size (e.g., corresponding to a page size) prior to writing out the entire block to the L3 cache 602 at one time. The gather buffer 610 may be operated in any of the manners described above, for example, as a FIFO or any other type of technique to control writing out a block of data that may have been modified multiple times.

While the foregoing is directed to embodiments of the present invention, other and further embodiments of the invention may be devised without departing from the basic scope thereof, and the scope thereof is determined by the claims that follow.

What is claimed is:

1. A method of operating a hierarchical cache system in a store-through mode, the cache system including at least a first level (L1) data cache accessible by a pipelined execution unit and a second level (L2) cache, the method comprising:
receiving a store instruction by the pipelined execution unit with store data to be stored at a targeted memory address; and
sending the store data to be stored in the L2 cache without stalling the pipelined execution unit if a cache line containing the targeted memory address is not contained in the L1 data cache.

2. The method of claim 1, further comprising:
writing the store data to the L1 data cache if a cache line containing the targeted memory address is contained in the L1 data cache.

3. The method of claim 1, wherein:
the store-through mode can be enabled and disabled; and
when the store-through mode is disabled, if a cache line containing the targeted memory address is not contained in the L1 data cache, the pipelined execution unit is stalled while the cache line containing the targeted memory address is fetched.

4. The method of claim 3, further comprising enabling the store-through mode under software control.

5. The method of claim 3, further comprising enabling the store-through mode under hardware control based on or more monitored parameters related to performance of the pipelined execution unit.

6. The method of claim 1, wherein sending the store data to be stored in the L2 cache comprises:
updating a cache line containing the targeted memory address in a buffer prior to storing the store data in the L2 cache; and
wherein the cache line is updated in the buffer multiple times prior to sending the cache line from the buffer to the L2 cache.

7. The method of claim 1, wherein sending the store data to be stored in the L2 cache comprises utilizing at least some portion of a bus used to fetch data from the L2 cache.

8. An integrated circuit device comprising:
a first level (L1) data cache;
a second level (L2) cache;
at least one processor core having a pipelined execution unit configured to receive a store instruction with store data to be stored at a targeted memory address; and
cache control circuitry configured to send the store data to be stored in the L2 cache without causing the pipelined execution unit to stall if a cache line containing the targeted memory address is not contained in the L1 data cache.

9. The device of claim 8, wherein the cache control circuitry is configured to:
write the store data to the L1 data cache if a cache line containing the targeted memory address is contained in the L1 data cache.

10. The device of claim 8, wherein:
the store-through mode can be enabled and disabled; and
when the store-through mode is disabled, the cache control circuitry is configured to, if a cache line containing the targeted memory address is not contained in the L1 data cache, stall the pipelined execution unit while the cache line containing the targeted memory address is fetched.

11. The device of claim 8, further comprising a register having a bit allowing the store-through mode to be enabled under software control.

12. The device of claim 8, further comprising logic configured to automatically enable the store-through mode based on or more monitored parameters related to performance of the pipelined execution unit.

13. The device of claim 8, further comprising:
a buffer for storing one or more cache lines; and
wherein the cache control circuitry is configured to update a cache line containing the targeted memory address in the buffer prior to storing the store data in the L2 cache.

14. The device of claim 8, wherein sending the store data to be stored in the L2 cache comprises utilizing at least some portion of a bus used to fetch data from the L2 cache.

15. The device of claim 8, wherein the processor core comprises:
one or more cascaded delayed execution pipeline units, each having at least first and second execution pipelines, wherein instructions in a common issue group issued to the execution pipeline unit are executed in the first execution pipeline before the second execution pipeline and a forwarding path for forwarding results generated by executing a first instruction in the first execution pipeline to the second execution pipeline for use in executing a second instruction.

16. A system, comprising:
a processor device having a first level (L1) data cache and a second level (L2) cache and at least one processor core having a pipelined execution unit configured to receive a store instruction with store data to be stored at a targeted memory address;
at least a third level (L3) cache; and
cache control circuitry configured to, in a L3 store-through mode, send the store data to be stored in the L3 cache if a cache line containing the targeted memory address is not contained in the L2 data cache.

17. The system of claim 16, wherein the L3 cache is located externally to the processor device.

18. The system of claim 16, wherein the L3 store-through mode can be enabled and disabled under at least one of: hardware control and software control.

19. The system of claim 16, wherein the cache control circuitry is configured to:
write the store data to the L2 cache if a cache line containing the targeted memory address is contained in the L2 data cache.

20. The system of claim 16, further comprising:
a buffer for storing one or more blocks of data to be written out to the L3 cache; and
wherein the cache control circuitry is configured to update a block of data containing the targeted memory address in the buffer prior to storing the store data in the L3 cache.
